(19) United States
(12) Patent Application Publication
(10) Pub. No.: US 2021/0233469 A1
(43) Pub. Date: Jul. 29, 2021

(54) PIXEL DRIVING CIRCUIT AND METHOD, AND DISPLAY PANEL

(71) Applicants: Chongqing BOE Optoelectronics Technology Co., Ltd., Chongqing (CN); BOE Technology Group Co., Ltd., Beijing (CN)

(72) Inventors: Shuai CHEN, Beijing (CN); Xiuzhu TANG, Beijing (CN); Jianfeng YUAN, Beijing (CN); Hailong WU, Beijing (CN); Xing DONG, Beijing (CN); Zhenguo TIAN, Beijing (CN); Lijun XIONG, Beijing (CN); Xuebo LIANG, Beijing (CN); Xiaoke ZHOU, Beijing (CN); Jinjin CHEN, Beijing (CN); Tongguo MA, Beijing (CN)

(21) Appl. No.: 17/053,589

(22) PCT Filed: Apr. 8, 2020
(86) PCT No.: PCT/CN2020/083682

§ 371 Date: Nov. 6, 2020

(30) Foreign Application Priority Data
Apr. 19, 2019 (CN) 201910319618.7

(51) Int. Cl. G09G 3/3233

(52) U.S. Cl. CPC G09G 3/3233; G09G 2300/0842; G09G 2300/0819; G09G 2320/0233; G09G 2300/0426

(57) ABSTRACT

Provided are a pixel driving circuit, a pixel driving method and a display panel. The pixel driving circuit includes: a driving circuit, a light emitting circuit, a storage circuit, a reset circuit, a light emitting control circuit and a writing compensation circuit; a first electrode of the storage circuit is coupled to a first node, a second electrode of the storage circuit is coupled to a second node; the reset circuit adjusts voltages of the first node and the second node; the writing compensation circuit writes a data signal of a data line terminal and a compensation data into the driving circuit through an adjustment of the storage circuit; the light emitting control circuit writes a display current, a magnitude of which is related only to the data signal and a voltage of the first voltage terminal, to the light emitting circuit by controlling the driving circuit.

### CROSS REFERENCE TO RELATED APPLICATIONS

The present application claims priority to Chinese patent application No. 201910319618.7 filed by the Chinese Intellectual Property Office on Apr. 19, 2019, the entire contents of which are incorporated herein by reference.

### TECHNICAL FIELD

The present disclosure relates to the field of display technology, and particularly relates to a pixel driving circuit, a pixel driving method and a display panel.

### BACKGROUND

Active Matrix Organic Light Emitting Diode (AMOLED) panels are used more and more widely. Pixel display devices of the AMOLED panel are Organic Light-Emitting Diodes (OLEDs), and the AMOLED panel can emit light by generating a driving current through a driving thin film transistor in a saturated state to drive the light-emitting device to emit light.

### SUMMARY

An embodiment of the present disclosure provides a pixel driving circuit including: a driving circuit, a light emitting circuit, a storage circuit, a reset circuit, a light emitting control circuit and a writing compensation circuit, where the driving circuit is configured to drive the light emitting circuit to emit light; a first terminal of the storage circuit is coupled to a first node, and a second terminal of the storage circuit is coupled to a second node; the reset circuit is configured to adjust voltages of the first node and the second node according to a first voltage terminal and a second voltage terminal; the writing compensation circuit is configured to write a data signal of a data line terminal and a compensation data into the driving circuit through an adjustment of the storage circuit; the light emitting control circuit is configured to write a display current to the light emitting circuit by controlling the driving circuit, the display current having a magnitude related only to the data signal and a voltage of the first voltage terminal.

In some implementations, the reset circuit includes: a first transistor, where a gate of the first transistor is coupled to a first gate line terminal, a first electrode of the first transistor is coupled to the first node, and a second electrode of the first transistor is coupled to the first voltage terminal; a second transistor, where a gate of the second transistor is coupled to a second gate line terminal, a first electrode of the second transistor is coupled to the second node, and a second electrode of the second transistor is coupled to the second voltage terminal.

In some implementations, the writing compensation circuit includes: a third transistor, a gate of the third transistor is coupled to a third gate line terminal, a first electrode of the third transistor is coupled to the second node, and a second electrode of the third transistor is coupled to a third node; and a fourth transistor, where a gate of the fourth transistor is coupled to the third gate line terminal, a first electrode of the fourth transistor is coupled to a fourth node, and a second electrode of the fourth transistor is coupled to the data line terminal.

In some implementations, the light emitting control circuit includes: a fifth transistor, where a gate of the fifth transistor is coupled to a first signal terminal, a first electrode of the fifth transistor is coupled to a third voltage terminal, and a second electrode of the fifth transistor is coupled to the third. node; and a sixth transistor, where a gate of the sixth transistor is coupled to the first signal terminal, a first electrode of the sixth transistor is coupled to the fourth node, and a second electrode of the sixth transistor is coupled to the light emitting circuit.

In some implementations, the pixel driving circuit further includes: a seventh transistor, where a gate of the seventh transistor is coupled to the first signal terminal, a first electrode of the seventh transistor coupled to the first node, and a second electrode of the seventh transistor coupled to the third voltage terminal.

In some implementations, the driving circuit includes: an eighth transistor, where a gate of the eighth transistor is coupled to the second node, a first electrode of the eighth transistor is coupled to the third node, and a second electrode of the eighth transistor is coupled to the fourth node.

In some implementations, the storage circuit includes: a storage capacitor having a first electrode coupled to the first node and a second electrode coupled to the second node.

In some implementations, all transistors are N-type transistors; or, all transistors are P-type transistors. An embodiment of the present disclosure provides a pixel driving method based on the above pixel driving circuit, the pixel driving method including a reset stage, a data writing stage and a display stage, where:

in the reset stage, the reset circuit adjusts voltages of the first node and the second node according to signals input by the first voltage terminal and the second voltage terminal;

in the data writing stage, the writing compensation circuit writes a data signal of the data line terminal and a compensation data into the driving circuit through an adjustment of the storage circuit;

in the display stage, the light emitting control circuit writes a display current to the light emitting circuit by controlling the driving circuit, a magnitude of the display current being related only to the data signal and a voltage of the first voltage terminal.

In some implementations, the reset circuit includes a first transistor and a second transistor, a gate of the first transistor is coupled to the first gate line terminal, a first electrode of the first transistor is coupled to the first node, a second electrode of the first transistor is coupled to the first voltage terminal, a gate of the second transistor is coupled to the second gate line terminal, a first electrode of the second transistor is coupled to the second node, and a second electrode of the second transistor is coupled to the second voltage terminal; the writing compensation circuit includes a third transistor and a fourth transistor, where a gate of the third transistor is coupled to the third gate line terminal, a first electrode of the third transistor is coupled to the second node, a second electrode of the third transistor is coupled to the third node, a gate of the fourth transistor is coupled to the third gate line terminal, a first electrode of the fourth transistor is coupled to the fourth node, and a second electrode of the fourth transistor is coupled to the data line terminal; the light emitting control circuit includes a fifth transistor and a sixth transistor, a gate of the fifth transistor is coupled to the first signal terminal, a first electrode of the fifth transistor is coupled to the third voltage terminal, a second electrode of the fifth transistor is coupled to the third node, a gate of the sixth transistor is coupled to the first signal terminal, a first electrode of the sixth transistor is coupled to the fourth node, and a second electrode of the sixth transistor is coupled to the light emitting circuit; the pixel driving circuit further includes a seventh transistor, where a gate of the seventh transistor is coupled to the first signal terminal, a first electrode of the seventh transistor is coupled to the first node, and a second electrode of the seventh transistor is coupled to the third voltage terminal; the driving circuit includes an eighth transistor, a gate of the eighth transistor is coupled to the second node, a first electrode of the eighth transistor is coupled to the third node, and a second electrode of the eighth transistor is coupled to the fourth node; the storage circuit includes a storage capacitor having a first electrode coupled to the first node and a second electrode coupled to the second node, and

the pixel driving method further includes:

in the reset stage, inputting a reset signal to the first voltage terminal and the second voltage terminal, inputting a turn-on signal to the first gate line terminal and the second gate line terminal, and inputting a turn-off signal to the third gate line terminal and the first signal terminal;

in the data writing stage, inputting the data signal to the data line terminal, inputting the turn-on signal to the first gate line terminal and the third gate line terminal, and inputting the turn-off signal to the second gate line terminal and the first signal terminal; and

in the display stage, inputting a display voltage to the third voltage terminal, inputting a turn-on signal to the first signal terminal, and inputting the turn-off signal to the first gate line terminal, the second gate line terminal and the third gate line terminal.

An embodiment of the present disclosure provides a display panel including a plurality of pixel driving circuits, each of which is the pixel driving circuit described above.

### DESCRIPTION OF DRAWINGS

FIG. 1 is a schematic structural diagram of a pixel driving circuit in the related art;

FIG. 2 is a schematic structural diagram of a pixel driving circuit according to an embodiment of the present disclosure;

FIG. 3 is a timing diagram illustrating operations of the pixel driving circuit shown in FIG. 2;

FIG. 4a is an equivalent circuit diagram of the pixel driving circuit shown in FIG. 2 during a reset stage;

FIG. 4b is an equivalent circuit diagram of the pixel driving circuit shown in FIG. 2 during a data writing stage;

FIG. 4c is an equivalent circuit diagram of the pixel driving circuit shown in FIG. 2 during a display stage.

### DESCRIPTION OF EMBODIMENTS

In order that those skilled in the art will better understand the technical solutions of the present disclosure, the following detailed description is given with reference to the accompanying drawings and the specific embodiments.

The present disclosure will be described in more detail below with reference to the accompanying drawings. Like elements are denoted by like reference signs throughout the various figures. For purposes of clarity, the various features in the drawings are not drawn to scale. Moreover, certain well-known elements may not be shown in the figures.

Numerous specific details of the present disclosure, such as structures, materials, dimensions, processing and techniques of the components, are set forth in the following description in order to provide a more thorough understanding of the present disclosure. However, as will be understood by those skilled in the art, the present disclosure may be practiced without these specific details.

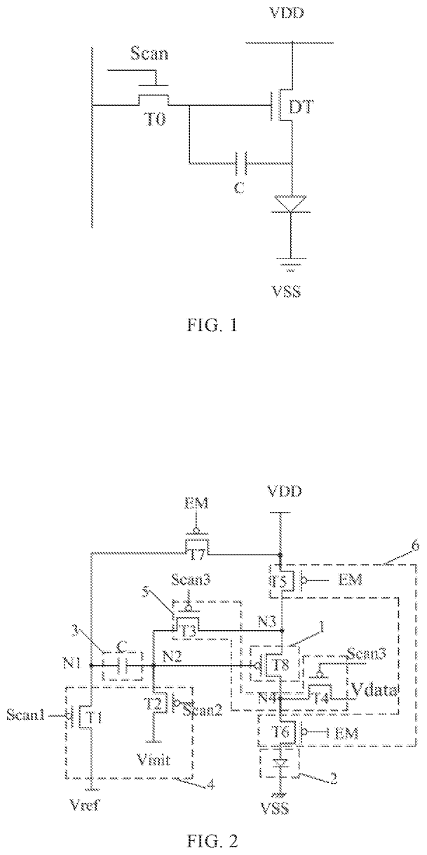

As shown in FIG. 1, a basic pixel driving circuit in the related art employs a 2T1C circuit, and the 2T1C circuit includes two thin film transistors (a switching transistor TO and a driving transistor DT) and one storage capacitor C.

However, in the conventional low temperature polysilicon process, uniformity among threshold voltages Vth of the driving transistors on theof a display substrate is poor, and thus when a same data voltage is input to the driving transistors, different driving currents are generated due to different threshold voltages of the driving transistors, and the uniformity of brightness of the light emitting devices is poor. In addition, since an entire display panel is driven by a power supply voltage and has a relatively high power consumption, and especially in a case where the display panel has a large size, voltage drop caused by parasitic resistance of a power supply line cannot be ignored, which causes non-uniformity of brightness of the display panel.

In view of the above, as shown in FIGS. 2 to 4, an embodiment of the present disclosure provides a pixel driving circuit including: a driving circuit 1, a light emitting circuit 2, a storage circuit 3, a reset circuit 4, a light emitting control circuit 6, and a writing compensation circuit 5. The driving circuit I is configured to drive the light emitting circuit 2 to emit light. A first terminal of the storage circuit 3 is coupled to a first node N1, and a second terminal of the storage circuit 3 is coupled to a second node N2. The reset circuit 4 is configured to adjust voltages of the first node N1 and the second node N2 according to a first voltage terminal Vref and a second voltage terminal Vinit. The writing compensation circuit 5 is configured to write a data. signal of a data line terminal Vdata and a compensation data to the driving circuit 1 through an adjustment of the storage circuit 3. The light emitting control circuit 6 is configured to write a display current to the light emitting circuit 2 by controlling the driving circuit I, a magnitude of the display current being related to the data signal and a voltage of the first voltage terminal Vref.

Specifically, the reset circuit 4 includes:

a first transistor T1 having a gate coupled to a first gate line terminal Scan1, a first electrode coupled to the first node N1, and a second electrode coupled to the first voltage terminal Vref;

a second transistor T2 having a gate coupled to a second gate line terminal Scan2, a first electrode coupled to the second node N2, and a second electrode coupled to the second voltage terminal Vinit.

The writing compensation circuit 5 includes:

a third transistor T3 having a gate coupled to a third gate line terminal Scan3, a first electrode coupled to the second node N2, and a second electrode coupled to a third node N3;

a fourth transistor T4 having a gate coupled to the third gate line terminal Scan3, a first electrode coupled to a fourth node N4, and a second electrode coupled to the data line terminal Vdata.

The light emitting control circuit 6 includes:

a fifth transistor T5 having a gate coupled to a first signal terminal EM, a first electrode coupled to a third voltage terminal VDD, and a second electrode coupled to the third node N3;

a sixth transistor T6 having a gate coupled to the first signal terminal EM, a first electrode coupled to the fourth node N4, and a second electrode coupled to the light emitting circuit 2.

The driving circuit 1 includes:

an eighth transistor TS having a gate coupled to the second node N2, a first electrode coupled to the third node N3, and a second electrode coupled to the fourth node N4.

The storage circuit 3 includes:

a storage capacitor C having a first electrode coupled to the first node N1 and a second electrode coupled to the second node N2.

The pixel driving circuit further includes: a seventh transistor T7 having a gate coupled to the first signal terminal EM, a first electrode coupled to the first node N1, and a second electrode coupled to the third voltage terminal VDD.

In some implementations, all transistors are N-type transistors; or, all transistors are P-type transistors.

In the present embodiment, the third voltage terminal is configured to provide an operation voltage VDD, and the fourth voltage terminal is configured to provide a common ground voltage VSS.

It should be noted that the light emitting circuit 2 in the present embodiment may be a current-driven light emitting device including an LED (Light Emitting Diode) or an OLED (Organic Light Emitting Diode) in the related art, and the OLED is taken as an example in the present embodiment for description. The light emitting circuit 2 has a first electrode coupled to the fourth node N4 and a second electrode coupled to the fourth voltage terminal VSS.

An embodiment of the present application further provides a pixel driving method based on the pixel driving circuit described above, the pixel driving method includes a reset stage t1, a data writing stage t2 and a display stage t3.

In the reset stage t1, the reset circuit 4 adjusts voltages of the first node N1 and the second node N2 according to the first voltage terminal Vref and the second voltage terminal Vinit.

In the data writing stage t2, the writing compensation circuit 5 writes a data signal of the data line terminal Vdata and a compensation data to the driving circuit 1 by an adjustment of the storage circuit 3.

In the display stage t3, the light emitting control circuit 6 writes a display current, a magnitude of which is related to the data signal and the voltage of the first voltage terminal Vref, to the light emitting circuit 2 by controlling the driving circuit 1.

Specifically, in the pixel driving method, the third voltage terminal VDD is configured to provide the operation voltage, and the fourth voltage terminal VSS is configured to provide the common ground voltage; the pixel driving method includes steps S11, S12 and S13.

In step S11, i.e., in the reset stage t1, a reset signal is input to the first voltage terminal (a reference voltage terminal) Vref and the second voltage terminal (an initialization voltage terminal) Vinit, i.e., the first voltage terminal Vref is input with a first voltage (a reference voltage), the second. voltage terminal Vinit is input with a second voltage (an initialization voltage), a turn-on signal is input to the first gate line terminal Scan1 and the second gate line terminal Scan2, and a turn-off signal is input to the third gate line terminal Scan3 and the first signal terminal EM.

The turn-on signal refers to a signal that can turn on the transistor when applied to the gate of the transistor, and the turn-off signal refers to a signal that can turn off the transistor when applied to the gate of the transistor.

In the following description, all transistors are P-type transistors, and therefore, the turn-on signal is a low level signal and the turn-off signal is a high level signal.

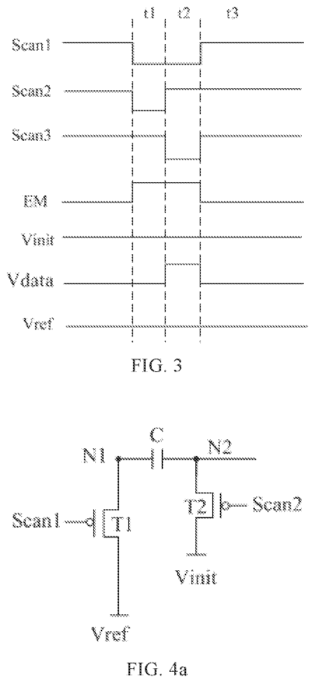

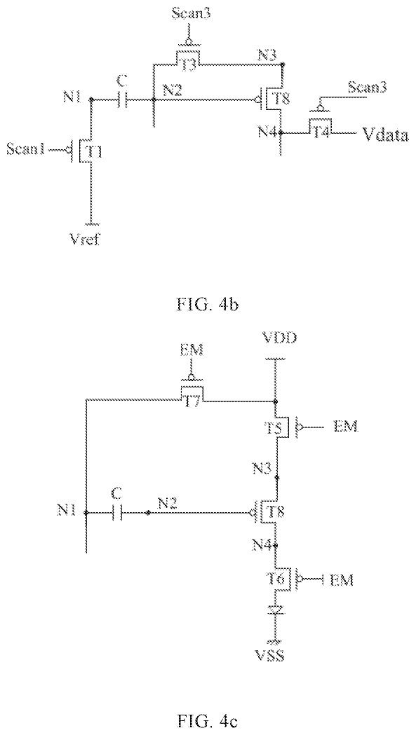

As shown in FIGS. 3 and 4a, in the reset stage, that is, a high level is input to the third gate line terminal Scan3, so that the third transistor T3 and the fourth transistor T4 are turned off; a high level is input to the first signal terminal EM, so that the fifth transistor T5, the sixth transistor T6 and the seventh transistor T7 are turned off. A low level is input to the first gate line terminal Scan1, the first transistor T1 is turned on, so that the voltage of the first voltage terminal Vref is written into the first node N1; a low level is input to the second gate line terminal Scan2, the second transistor T2 is turned on, so that the initial voltage of the second voltage terminal Vinit is written into the second node N2, thereby the voltage across both electrodes of the storage capacitor C is initialized.

In step S12, i.e., in the data writing stage t2, the data signal Vdata is input to the data line terminal Vdata, the turn-on signal is input to the first gate line terminal Scan' and the third gate line terminal Scan3, and the turn-off signal is input to the second gate line terminal Scan2 and the first signal terminal EM.

As shown in FIGS. 3 and 4b, in the data writing stage, a high level is input to the second gate line terminal Scan2, the second transistor T2 is turned off; a high level is input to the first signal terminal EM, so that the fifth transistor T5, the sixth transistor T6 and the seventh transistor T7 are turned off. A low level is input to the third gate line terminal Scan3, so that the third transistor 13 and the fourth transistor T4 are turned on; a low level is input to the first gate line terminal Scan1 so that the first transistor T1 is turned on. Since the second node N2 maintains the initialization voltage at low level during the previous stage, the eighth transistor T8 is turned on. Thus, the data signal is written to the second node N2 sequentially through the fourth transistor T4, the eighth transistor T8 and the third transistor 13, and at this time, the voltage of the second node N2 becomes a sum of voltage of the data signal voltage and a threshold voltage of the eighth transistor T8, i.e., (Vdata+Vth), while the voltage of the first node N1 is still the voltage of the first voltage terminal Vref.

In step S13, i.e., in the display stage t3, a display voltage is input to the third voltage terminal VDD, a turn-on signal is input to the first signal terminal EM, and a turn-off signal is input to the first gate line terminal Scan1, the second gate line terminal Scan2 and the third gate line terminal Scan3.

As shown in FIGS. 3 and 4c, in this display stage, a high level is input to the first gate line terminal Scan1, so that the first transistor T1 is turned off; a high level is input to the second gate line terminal Scan2, so that the second transistor 12 is turned off; a high level is input to the third gate line terminal Scan3, so that the third transistor T3 and the fourth transistor 14 are turned off. A low level is input to the first signal terminal EM, so that the fifth transistor T5, the sixth transistor T6 and the seventh transistor T7 are turned on. When the seventh transistor T7 is turned on, the voltage of the first node N1 is changed from the voltage of the first voltage terminal Vref in the previous stage to the voltage of the third voltage terminal ADD. The first node N1 is in a floating state due to turn-off of the first transistor T1, and the voltage of the second node N2 changes along with the change of the voltage of the first node N1 due to the bootstrap effect of the storage capacitor C, that is, the voltage of the second node N2 changes from Vdata+Vth in the previous stage to Vdata+Vth+VDD−Vref.

At this time, the eighth transistor T8 drives the light emitting circuit 2 to emit light. A voltage Vn2 of the first electrode (source) of the eighth transistor T8 is equal to VDD, and a gate voltage (i.e., the voltage of the second node N2) Vn1 of the eighth transistor 18 is equal to VDD−Vref+Vdata+Vth, and thus the gate-source voltage Vgs of the eighth transistor T8 is equal to Vdata+Vth−Vref, that is, Vgs=Vn1−Vn2=(VDD−Vref+Vdata+Vth)−VDD=Vdata+Vth−Vref.

As can be seen that, the gate-source voltage of the eighth transistor T8 is not affected by the voltage of the third voltage terminal VDD, and thus the influence of the voltage of the third voltage terminal VDD on the display current can be avoided.

Further, the display current I_{OLED} flowing through the light emitting circuit 2 is equal to β(Vdata−Vref)², that is, I_{OLED}=β(Vgs−Vth)²=β(Vdata+Vth−Vref−Vth)²=β(Vdata−Vref)²,

where β=1/2μₙcₒₓ (W/L), μₙ denotes an electron mobility of the eighth transistor T8, cₒₓ denotes an insulation capacitance per unit area, and W/L denotes a width-to-length ratio of an active region of the eighth transistor T8.

It can be seen that the display current of the light emitting circuit 2 is independent of the threshold voltage of the eighth transistor T8 in the display stage t3, and β is a constant determined after the manufacturing process of a display panel is determined, and thus the display current of the light emitting circuit 2 is influenced only by the voltage Vdata of the data signal and the voltage of the first voltage terminal Vref.

In the present embodiment, VDD may indicate a high voltage signal, VSS may indicate a low voltage signal, and Vinit may indicate a voltage lower than VSS.

In the pixel driving circuit of the present embodiment, when the driving circuit 1 drives the light emitting circuit 2 to emit light (perform pixel display), the display current is written into the light emitting circuit 2, and the magnitude of the display current is related to the data signal and the voltage of the first voltage terminal Vref, but is independent of the threshold voltage of the driving circuit 1, and thus the influence of the threshold voltage (Vth) of the driving circuit 1 on the display current of the light emitting circuit 2 is eliminated, and the brightness uniformity of light emitting circuits 2 in the display device is effectively improved In addition, an electrode of the capacitor is coupled to VDD through the seventh transistor T7, which effectively compensates the effect of IR drop, thereby further improving the non-uniformity of display brightness.

An embodiment of the present disclosure provides a display panel including a plurality of pixel driving circuits, at least one of which is the pixel driving circuit described above.

Specifically, the display panel may be any product or component having a display function, such as an Organic Light Emitting Diode (OLED) display panel, electronic paper, a mobile phone, a tablet computer, a television, a display, a notebook computer, a digital photo frame, and a navigator.

It should be noted that, in the present disclosure, relational terms such as first and second, and the like are used solely to distinguish one entity or action from another entity or action without necessarily requiring or implying any actual such relationship or order between such entities or actions. Also, the terms “comprises,” “includes” or any other variation thereof, are intended to cover a non-exclusive inclusion, such that a process, method, article, or apparatus that comprises a list of elements include not only those elements but also other elements not expressly listed or inherent to such process, method, article, or apparatus. Without further limitation, an element defined by the phrase “comprising an . . . ” does not exclude the presence of other identical elements in the process, method, article, or apparatus that comprises the element.

In accordance with the disclosed embodiments, as described above, these embodiments are not intended to be exhaustive or to limit the present disclosure to the precise embodiments disclosed. Obviously, many modifications and variations are possible in light of the above teaching. The embodiments were chosen and described in order to best explain the principles of the present disclosure and the practical application, to thereby enable others skilled in the art to best utilize the present disclosure and modifications based on the present disclosure. The present disclosure is to be limited only by the claims and full scope and equivalents thereof.

1. A pixel driving circuit, comprising: a driving circuit, a light emitting circuit, a storage circuit, a reset circuit, a light emitting control circuit and a writing compensation circuit,
wherein
the driving circuit is configured to drive the light emitting circuit to emit light;
a first terminal of the storage circuit is coupled to a first node, and a second terminal of the storage circuit is coupled to a second node;
the reset circuit is configured to adjust voltages of the first node and the second node according to a first voltage terminal and a second voltage terminal;
the writing compensation circuit is configured to write a data signal of a data line terminal and a compensation data into the driving circuit through an adjustment of the storage circuit;
the light emitting control circuit is configured to write a display current to the light emitting circuit by controlling the driving circuit, the display current having a magnitude related only to the data signal and a voltage of the first voltage terminal.

2. The pixel driving circuit according to claim 1, wherein the reset circuit comprises:
a first transistor, wherein a gate of the first transistor is coupled to a first gate line terminal, a first electrode of the first transistor is coupled to the first node, and a second electrode of the first transistor is coupled to a first voltage terminal;
a second transistor, wherein a gate of the second transistor is coupled to a second gate line terminal, a first electrode of the second transistor is coupled to the second node, and a second electrode of the second transistor is coupled to a second voltage terminal.

3. The pixel driving circuit according to claim 1, wherein the writing compensation circuit comprises:
a third transistor, wherein a gate of the third transistor is coupled to a third gate line terminal, a first electrode of the third transistor is coupled to the second node, and a second electrode of the third transistor is coupled to a third node;
a fourth transistor, wherein a gate of the fourth transistor is coupled to the third gate line terminal, a first electrode of the fourth transistor is coupled to a fourth node, and a second electrode of the fourth transistor is coupled to the data line terminal.

4. The pixel driving circuit according to claim 1,
wherein the light emitting control circuit comprises:
a fifth transistor, wherein a gate of the fifth transistor is coupled to a first signal terminal, a first electrode of the fifth transistor is coupled to a third voltage terminal, and a second electrode of the fifth transistor is coupled to the third node;
a sixth transistor, wherein a gate of the sixth transistor is coupled to the first signal terminal, a first electrode of the sixth transistor is coupled to the fourth node, and a second electrode of the sixth transistor is coupled to the light emitting circuit.

5. The pixel driving circuit according to claim 1, further comprising:
a seventh transistor, wherein a gate of the seventh transistor is coupled to the first signal terminal, a first electrode of the seventh transistor is coupled to the first node, and a second electrode of the seventh transistor is coupled to the third voltage terminal.

6. The pixel driving circuit according to claim 1, wherein the driving circuit comprises:
an eighth transistor, wherein a gate of the eighth transistor is coupled to the second node, a first electrode of the eighth transistor is coupled to the third node, and a second electrode of the eighth transistor is coupled to the fourth node.

7. The pixel driving circuit according to claim 1, wherein the storage circuit comprises:
a storage capacitor having a first electrode coupled to the first node and a second electrode coupled to the second node.

8. The pixel driving circuit according to claim 6, wherein all the transistors are N-type transistors; or, all transistors are P-type transistors.

9. A pixel driving method based on the pixel driving circuit of claim 1, the pixel driving method comprising a reset stage, a data writing stage and a display stage, wherein:
in the reset stage, the reset circuit adjusts voltages of the first node and the second node according to signals input by the first voltage terminal and the second voltage terminal;
in the data writing stage, the writing compensation circuit writes a data signal of the data line terminal and a compensation data into the driving circuit through an adjustment of the storage circuit;
in the display stage, the light emitting control circuit writes a display current to the light emitting circuit by controlling the driving circuit, a magnitude of the display current being related only to the data signal and a voltage of the first voltage terminal.

10. The pixel driving method according to claim 9, wherein the reset circuit comprises a first transistor and a second transistor, a gate of the first transistor is coupled to a first gate line terminal, a first electrode of the first transistor is coupled to the first node, a second electrode of the first transistor is coupled to a first voltage terminal, a gate of the second transistor is coupled to a second gate line terminal, a first electrode of the second transistor is coupled to the second node, and a second electrode of the second transistor is coupled to a second voltage terminal; the writing compensation circuit comprises a third transistor and a fourth transistor, wherein a gate of the third transistor is coupled to a third gate line terminal, a first electrode of the third transistor is coupled to the second node, a second electrode of the third transistor is coupled to a third node, a gate of the fourth transistor is coupled to the third gate line terminal, a first electrode of the fourth transistor is coupled to a fourth node, and a second electrode of the fourth transistor is coupled to the data line terminal; the light emitting control circuit comprises a fifth transistor and a sixth transistor, a gate of the fifth transistor is coupled to a first signal terminal, a first electrode of the fifth transistor is coupled to a third voltage terminal, a second electrode of the fifth transistor is coupled to the third node, a gate of the sixth transistor is coupled to the first signal terminal, a first electrode of the sixth transistor is coupled to the fourth node, and a second electrode of the sixth transistor is coupled to the light emitting circuit; the pixel driving circuit further comprises a seventh transistor, wherein a gate of the seventh transistor is coupled to the first signal terminal, a first electrode of the seventh transistor is coupled to the first node, and a second electrode of the seventh transistor is coupled to the third voltage terminal; the driving circuit comprises an eighth transistor, a gate of the eighth transistor is coupled to the second node, a first electrode of the eighth transistor is coupled to the third node, and a second electrode of the eighth transistor is coupled to the fourth node; the storage circuit comprises a storage capacitor having a first electrode coupled to the first node and a second electrode coupled to the second node, and wherein
the pixel driving method further comprises:
in the reset stage, inputting a reset signal to the first voltage terminal and the second voltage terminal, inputting a turn-on signal to the first gate line terminal and the second gate line terminal, and inputting a turn-off signal to the third gate line terminal and the first signal terminal;
in the data writing stage, inputting the data signal to the data line terminal, inputting the turn-on signal to the first gate line terminal and the third gate line terminal, and inputting the turn-off signal to the second gate line terminal and the first signal terminal; and
in the display stage, inputting a display voltage to the third voltage terminal, inputting the turn-on signal to the first signal terminal, and inputting the turn-off signal to the first gate line terminal, the second gate line terminal and the third gate line terminal.

11. A display panel, comprising a plurality of pixel driving circuits, at least one of which is the pixel driving circuit of claim 1.

12. The pixel driving circuit according to claim 2, wherein the writing compensation circuit comprises:
a third transistor, wherein a gate of the third transistor is coupled to a third gate line terminal, a first electrode of the third transistor is coupled to the second node, and a second electrode of the third transistor is coupled to a third node;
a fourth transistor, wherein a gate of the fourth transistor is coupled to the third gate line terminal, a first electrode of the fourth transistor is coupled to a fourth node, and a second electrode of the fourth transistor is coupled to the data line terminal.

13. The pixel driving circuit according to claim 12, wherein the light emitting control circuit comprises:
a fifth transistor, wherein a gate of the fifth transistor is coupled to a first signal terminal, a first electrode of the fifth transistor is coupled to a third voltage terminal, and a second electrode of the fifth transistor is coupled to the third node;
a sixth transistor, wherein a gate of the sixth transistor is coupled to the first signal terminal, a first electrode of the sixth transistor is coupled to the fourth node, and a second electrode of the sixth transistor is coupled to the light emitting circuit.

14. The pixel driving circuit according to claim 13, further comprising:
a seventh transistor, wherein a gate of the seventh transistor is coupled to the first signal terminal, a first electrode of the seventh transistor is coupled to the first node, and a second electrode of the seventh transistor is coupled to the third voltage terminal.

15. The pixel driving circuit according to claim 14, wherein the driving circuit comprises:
an eighth transistor, wherein a gate of the eighth transistor is coupled to the second node, a first electrode of the eighth transistor is coupled to the third node, and a second electrode of the eighth transistor is coupled to the fourth node.

16. The pixel driving circuit according to claim 15, wherein the storage circuit comprises:
a storage capacitor having a first electrode coupled to the first node and a second electrode coupled to the second node.

17. A display panel, comprising a plurality of pixel driving circuits, at least one of which is the pixel driving circuit of claim 2.

18. A display panel, comprising a plurality of pixel driving circuits, at least one of which is the pixel driving circuit of claim 3.

19. A display panel, comprising a plurality of pixel driving circuits, at least one of which is the pixel driving circuit of claim 4.

20. A display panel, comprising a plurality of pixel driving circuits, at least one of which is the pixel driving circuit of claim 16.
